(19) United States
(12) Patent Application Publication
(10) Pub. No.: US 2007/0039011 A1
(43) Pub. Date: Feb. 15, 2007

(54) Optical disc drive

(75) Inventors: Chun-Ting Wu, Hsinchu (TW); Cheng-Fu Lee, Hsinchu (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/340,637

(22) Filed: Jan. 27, 2006

(30) Foreign Application Priority Data
Aug. 15, 2005 (TW) 094127715

(51) Int. Cl. G11B 17/04

(52) U.S. Cl. 720/604

(57) ABSTRACT

A disc drive comprises a housing provided with an opening; a disc loading device for loading a disc into or ejecting the disc out of the housing via the opening by means of rotation; a base seat movably installed in the housing in which a spindle motor and a pickup unit module are installed; and a joint mechanism installed in the housing for driving the base seat from a lower position to a higher position to support said disc on the spindle motor. Whereby, when the disc loading device is rotated out of the opening, the joint mechanism drives the base seat to the lower position; and when the disc loading device is rotated into the opening, the joint mechanism drives the base seat to the higher position meanwhile the spindle motor is raised to support the disc.

This Non-provisional application claims priority under 35 U.S.C. §119(a) on Patent Application No(s). 094127715 filed in Taiwan, Republic of China on Aug. 15, 2005, the entire contents of which are thereby incorporated by reference.

### FIELD OF THE INVENTION

The present invention relates to an optical disc drive, and more particularly to an optical disc drive with a rotation means for loading a disc in or out of it.

### DESCRIPTION OF RELATED ART

There are many types of optical disc drives developed currently, such as tray type, cover opening type, cassette type and slit-in type drives. The tray type disc drive is the most popular among these. A disc loading tray is mainly used to load a disc into the disc drive, and then a base seat in the drive is driven to elevate a predetermined distance to support the disc on a spindle motor disposed on the base seat to drive the disc rotating such that an optical pickup unit in the drive can read data on the disc.

Generally, tray type optical disc drive can be used in a level state and a vertical state. Please refer to FIG. 1. FIG. 1 is prospective view showing a conventional tray type disc drive used in a vertical state.

As the figure shows, the tray type disc drive 10 is placed on a supporting base S to use the disc drive 10 in a vertical state. However, when the tray type disc drive is used in the vertical state, the disc is supported on the tray by little area that will cause the disc to easily fall from the tray during the tray is loading into the disc drive. This leads to a situation that the disc cannot be loaded into the disc drive successfully and the disc drive cannot function.

Therefore, how to support the disc stately so as to load the disc into the disc drive smoothly is the topic of which the present invention takes a thorough study.

### SUMMARY OF THE INVENTION

One object of the present invention is to provide an optical disc drive which is capable of rotating an optical disc loading device to load a disc into or eject out of a drive by installing the loading device at any side of an opening of the drive.

Another object of the present invention is to provide an optical disc drive which is capable of raising a spindle motor to support and drive a disc to rotate by moving the base seat in the disc drive synchronously when a disc loading device is loading an optical disc into the drive.

For attaining the objects mentioned above, the present invention provides an optical disc drive which comprises a housing provided with an opening; a disc loading device for loading a disc into or ejecting the disc out of the housing via the opening by means of rotation; a base seat movably installed in said housing, in which a spindle motor and a pickup unit module are installed; and a joint mechanism installed in the housing for driving the base seat from a lower position to a higher position to support and drive the disc on the spindle motor and then the pickup unit module reads the data thereon. Namely, when the disc is rotated out of the opening, the joint mechanism drives the base seat to the lower position, and when the disc loading device is rotated into the opening, the joint mechanism drives the base seat to the higher position allowing the spindle motor to support and drive the disc.

According to a preferred embodiment of the present invention, the disc loading device is in an arc shape matching with the perimeter of a disc and has an accepting groove for accepting a disc in the disc loading device.

According to a preferred embodiment of the present invention, an elastic arm having a T-shape is extended from one side of the disc loading device, and a clip is disposed on one end of the elastic arm for clipping the disc. Moreover, a raised block is installed in the drive in the rotation route of the disc loading device. Whereby, when the disc loading device is rotated into the drive, the raised block presses the other end of the elastic arm to deform the elastic arm to release the clip from the disc for the spindle motor supporting the disc and driving it to rotate.

According to a preferred embodiment of the present invention, the joint mechanism comprises a joint body, a sliding block, and an elastic element, in which the joint body has a pivoting end, a pushed end and a joint end, in which the pivoting end has the same pivoting point as the disc loading device. Besides, the pushed end is located on a rotating route of the disc loading device. When the disc loading device is rotated into the housing, it pushes the pushed end to rotate the joint body and drive the sliding block to move the base seat from a lower position to a higher position so as to raise a spindle motor to support and rotate the disc. The elastic element is connected to the housing and the joint body and provide a spring force to move the joint body from a loaded position to an unloaded position, and therefore to move the base seat from the higher position to the lower position when the disc loading device is rotated out of the housing.

According to a preferred embodiment of the present embodiment, the optical disc drive further comprises a locking mechanism for fixing the disc loading device in a loaded position, which is installed in the housing and comprises a hook for locking the disc loading device, an electromagnetic plunger for controlling the hook to lock or release the disc loading device, and an elastic element for elastically moving the hook. Whereby, when the disc loading device is rotated into the drive, the hook will lock the disc loading device so as to fix it in the housing, and when the disc loading device is rotated out of the drive, the electromagnetic plunge is controlled to disengage the hook from the locked disc loading device to release it to rotate out of the housing.

### BRIEF DESCRIPTION OF THE DRAWINGS

The present invention can be more fully understood by reference to the following description and accompanying drawings, in which:

FIG. 1 is a schematic view, showing a conventional tray type disc drive used in a vertical state;

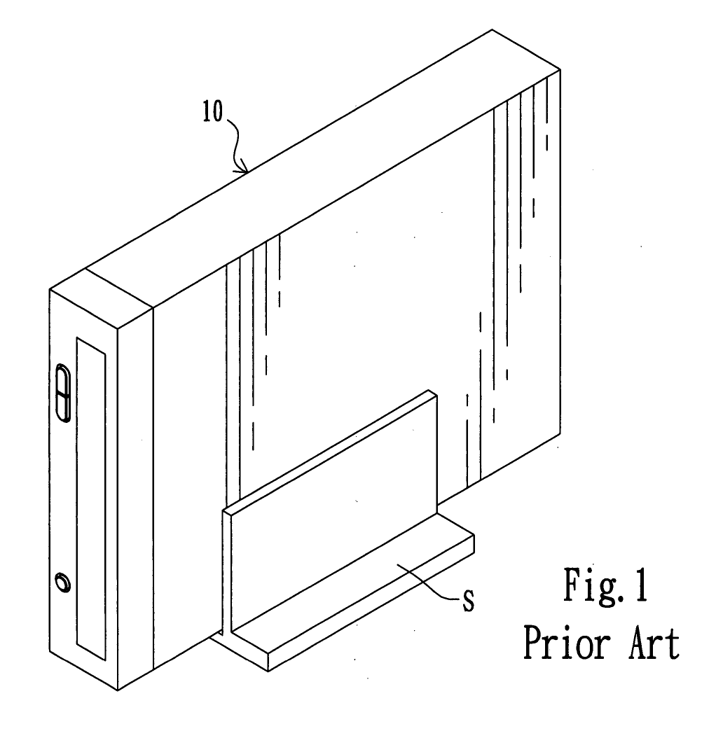

FIG. 2 is a perspective view, showing the structure of an optical disc drive according to a preferred embodiment of the present invention;

FIG. 3 is a cross sectional view, showing a disc drive of FIG. 2 with a disc loading device rotated out of a housing;

FIG. 4 is a cross sectional view, showing a disc drive of FIG. 2 with a disc loading device rotated into a housing;

FIG. 5 is a perspective view, showing a joint mechanism in the disc drive of FIG. 2;

FIG. 6 is an enlarged view, showing a relative position of a base seat and a sliding block of the disc drive of FIG. 2 wherein the base seat is at a lower position;

FIG. 7 is an enlarged view, showing a relative position of a base seat and a sliding block of the disc drive of FIG. 2 wherein the base seat is at a higher position.

### DETAILED DESCRIPTION OF THE PREFERRED EMBODIMENTS

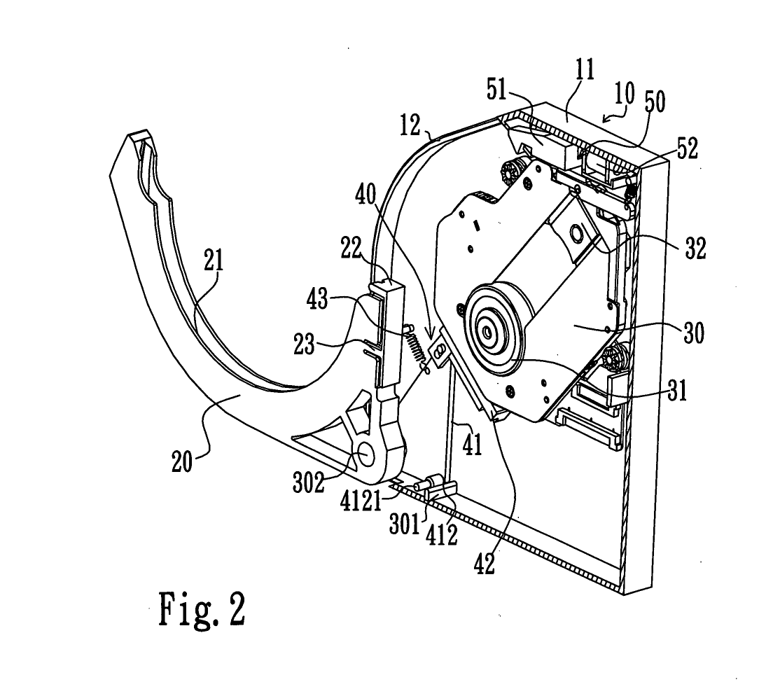

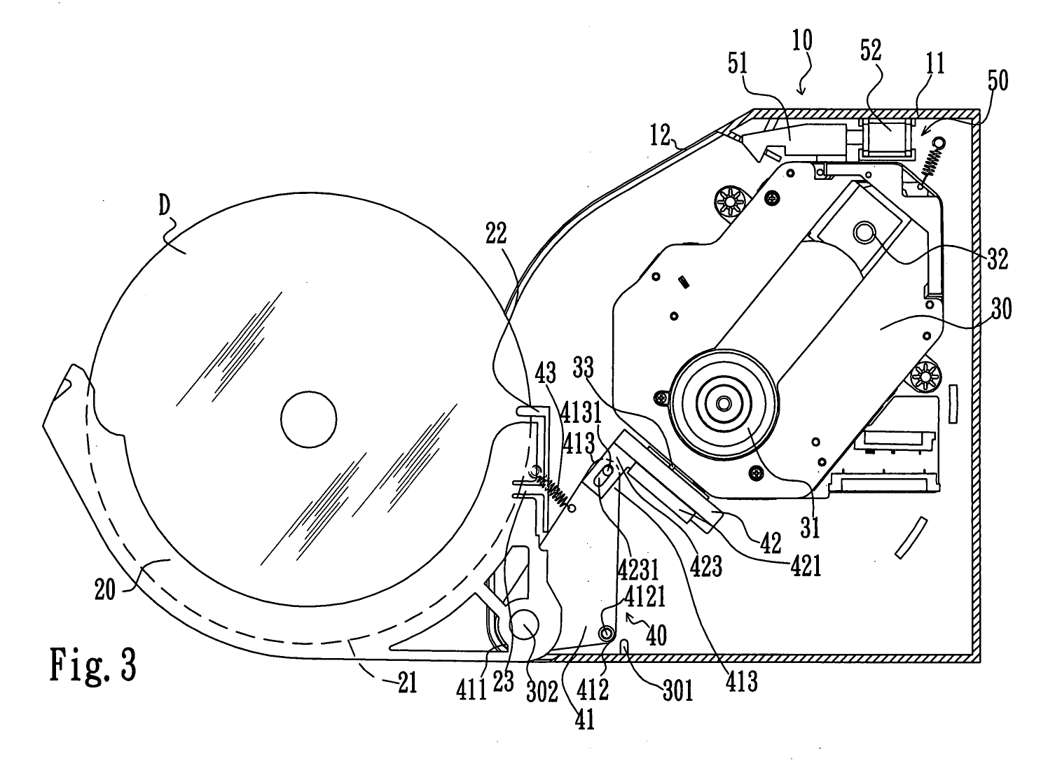

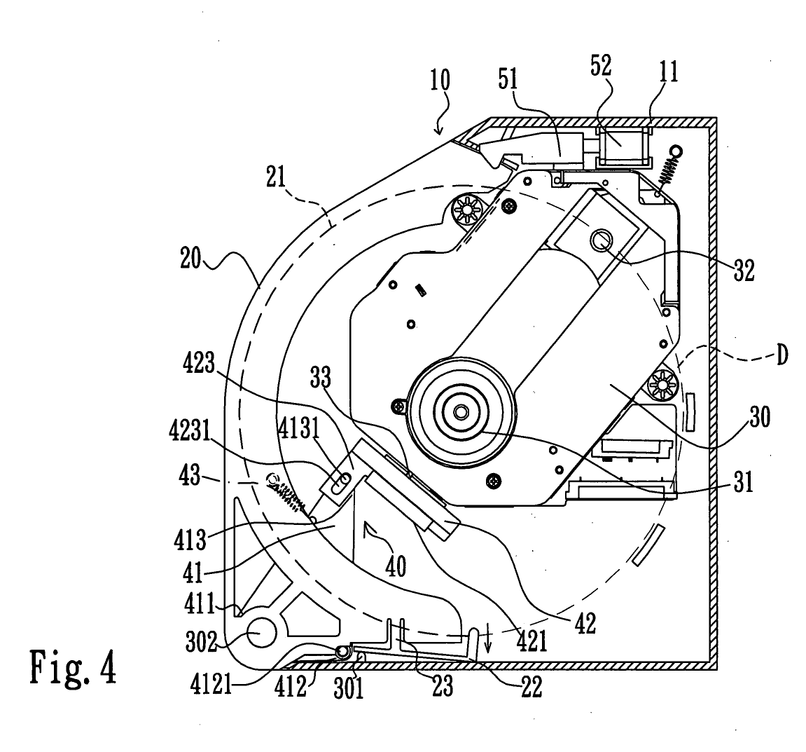

Please first refer to FIGS. 2, 3 and 4. FIG. 2 is a perspective view showing the structure of an optical disc drive according to a preferred embodiment of the present invention. FIG. 3 is a cross sectional view showing an optical disc drive of FIG. 2 in which a disc loading device is rotated out of a housing, and FIG. 4 is a cross sectional view showing an optical disc drive of FIG. 2 in which a disc loading device is rotated into a housing.

As the figures show, an optical disc drive 10 comprises a housing 11, a disc loading device 20 for loading a disc D, a base seat 30, and a joint mechanism 40, in which an opening 12 is disposed at one side of the housing 11 and the disc loading device 20 is pivotally connected at one side of the opening 12 so that the disc loading device 20 is rotated into or out of the housing 11 through the opening 12.

The disc loading device 20 is in an arc shape matching with the perimeter of a disc and has an accepting groove 21 for loading the disc D so that the disc D could be placed and supported in the accepting groove 21 to load it into the optical disc drive 10, as shown in FIGS. 3 and 4. Besides, an elastic arm 23 having a T-shape is extended from one side of the disc loading device 20, and a clip 22 is disposed on one end of the elastic arm 23 for clipping the disc D. Therefore, the disc D is accurately positioned in the accepting groove 21 when the disc loading device 20 is rotated into the disc drive 10. When the disc loading device 20 is completely rotated into the disc drive 10, the other end of the elastic arm 23 is pressed by a raised block 301 disposed in the disc drive 10 so as to deform the elastic arm 23 and separate the clip 22 from the disc D, as FIG. 4 shows. At this time, a spindle motor 31 is lifted up to support and drive the disc D to rotate.

A base seat 30 is installed in the housing 11 and moved between a lower position and a higher position. The spindle motor 31 used for driving the disc D and a pickup unit module 32 used for reading data on the disc D are installed on the base seat 30. Whereby, a joint mechanism 40 pivotally disposed in the housing 11 drives the base seat 30 to move from the lower position to the higher position meanwhile the spindle motor 31 is raised to support the disc D when the disc loading device 20 is rotated into the housing 11.

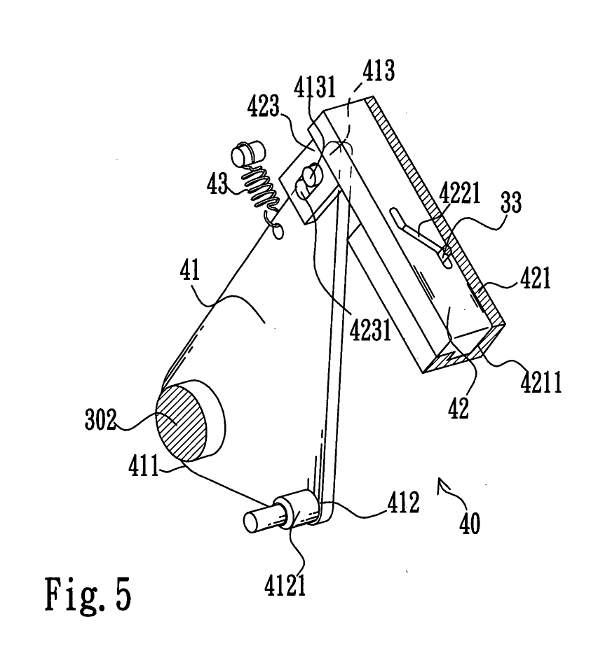

Please refer to FIG. 5. FIG. 5 is a perspective view showing a joint mechanism in the optical drive of FIG. 2. The joint mechanism 40 comprises a joint body 41, a sliding block 42, and an elastic element 43, in which the joint body 41 has three ends; they are a pivoting end 411, a pushed end 412 and a jointing end 413, respectively. The pivoting end 411 and the disc loading device 20 are similarly pivotally installed in the housing 11 by a pivoting axis 302, as FIG. 3 shows. The pushed end 412 has a pushed block 4121 positioned on the moving route of the disc loading device 20. The pushed block 4121 is pushed by the disc loading device 20 to rotate the joint body 41 from an unloaded position (as FIG. 3 shows) to a loaded position (as FIG. 4 shows) when the disc loading device 20 is rotated into the disc drive 10. Furthermore, a pin 4131 disposed on a surface of the jointing end 413 is connected to the sliding block 42 to move the sliding block 42 together to raise the base seat 30 from the lower position to the higher position.

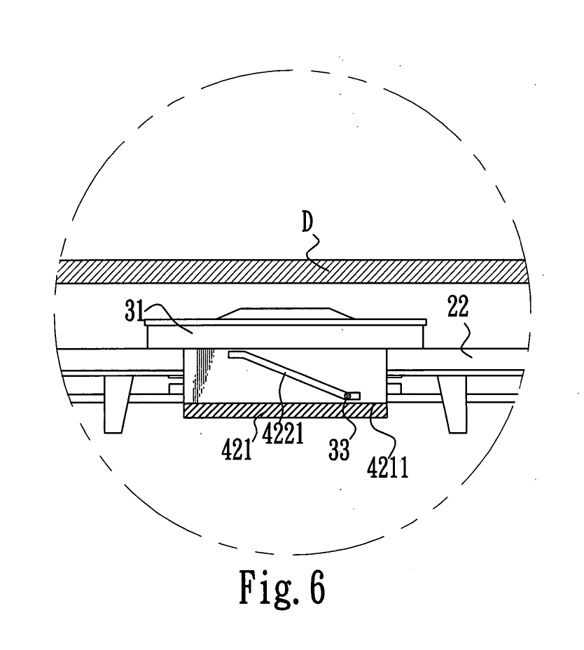

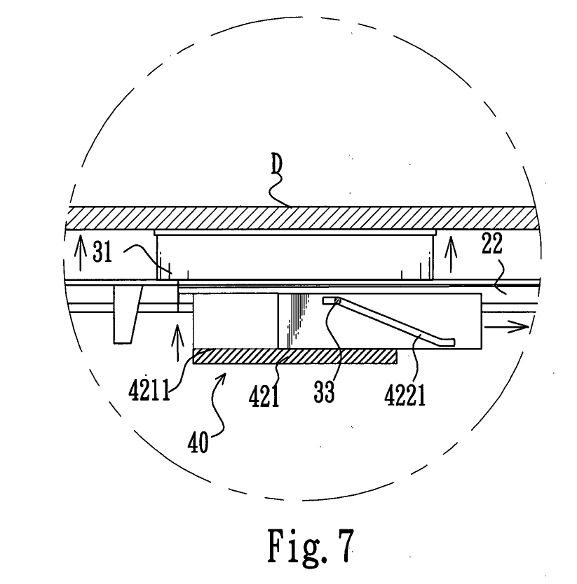

Please refer to FIG. 4 and FIGS. 5 to 7. FIGS. 6 and 7 are enlarged views respectively showing relative positions of a base seat and a sliding block of a disc drive of FIG. 2 wherein the base seats in the FIGS. 6 and 7 are at a lower position and a higher position, respectively.

The sliding block 42 is slidably installed at one side of the base seat 30, as FIG. 4 shows. And, a sloped guide groove 4221 is disposed at one side of the sliding block 42 adjacent to the base seat 30, and a ear 423 is disposed at another side of the sliding block 42 adjacent to the joint body 41. A sliding groove 4231 is disposed on the ear 423 and engages with the pin 4131 of the jointing end 413 of the joint body 41 to move the sliding block 42 when the joint body 41 is moved from the unloaded position to the loaded position.

Furthermore, the base seat 30 has a joint pin 33 engaged with the sloped guide groove 4221, as FIG. 5 shows. When the sliding block 42 is slid by the rotation of the disc loading device 22 into the disc drive 10, the joint pin 33 is moved in the sloped guide groove 4221 to raise the base seat 30 from the lower position to the higher position. More specifically, when the disc loading device 20 is not rotated into the housing 11, the base seat 30 is positioned at the lower position, as FIG. 6 shows. And, when the disc loading device 20 is rotated into the housing 11, the sliding block 42 is moved by the rotation of the joint body 41 to raise the base seat 30 to the higher position, as FIG. 7 shows, through the relative movement of the joint pin 33 and the sloped guide groove 4221.

According to this embodiment, the sliding block 42 is installed on a guide block 421; the guide block 421 has a guide groove 4211 to guide the sliding block 42 to move along the guide groove 4211.

Besides, as FIG. 5 shows, an elastic element 43 is connected to the joint body 41. Therefore, when the disc loading device 20 is rotated out of the housing 11, the above-mentioned joint body 41 is returned to the unloaded position through the elastic force of the elastic element 43.

Please refer to FIGS. 3 and 4 again. When the disc D is positioned in the accepting groove 21 disposed in the disc loading device 20, the disc D is guided to be fixed by the clip 22 installed at the side of the disc loading device 20 through the curve of the accepting groove 21. And, when the disc D is to be loaded into the disc drive 10, the user only pushes the disc loading device 20 to rotate into the disc drive 10 around the pivoting axis 302, as FIG. 4 shows. In the meantime, the side of the disc loading device 20 presses the pushed end 412 of the joint body 41 to move the joint shaft 41 from the unloaded position to the loaded position, and further to drive the sliding block 42 to raise the base seat 30 from the lower position to the higher position where the spindle motor 31 drives the disc D to rotate.

According to the disc drive of the present invention, when the joint body 41 is moved from the unloaded position to the loaded position, the pin 4131 at the joint end 413 of the joint body 41 is slid in the sliding groove 4231, the sliding block 42 is moved together. And, the joint pin 33 extended from the base seat 30 is slid in the sloped guide groove 4221 to raise the base seat 30 from the lower position to the higher position where the disc D is supported on the spindle motor 31.

Please refer to FIGS. 3 and 4 again, the disc drive according to the present invention further comprises a lock mechanism 50 installed in the disc drive 10 adjacent to one side of the opening 12 of the housing 11 opposite to the pivoting side of the disc loading device 20. The locking mechanism 50 comprises a hook 51 for locking the disc loading device 20, an electromagnetic plunger 52 for controlling the hook 51 to lock and release the disc loading device 20, and an elastic element for elastically moving the hook 51 (not shown in the figure). When the disc loading device 20 is rotated into the housing 11, the hook 51 locks the disc loading device 20 so as to fix it in the housing 11; and when the disc loading device 20 is rotated out of the housing 11, the electromagnetic plunger 52 is controlled to disengage the hook 51 from the locked disc loading device 20 to release it to rotate out of the housing 11.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disc drive, comprising:
a housing which is provided with an opening;
a disc loading device for loading a disc into or ejecting said disc out of said housing via said opening by means of rotation;
a base seat movably installed in said housing, in which a spindle motor for rotating said disc and a pickup unit module for reading data on said disc are installed; and
a joint mechanism installed in said housing for driving said base seat from a lower position to a higher position to support said disc on said spindle motor.

2. The disc drive according to claim 1, wherein said disc loading device is in an arc shape matching with the perimeter of a disc and has an accepting groove for containing said disc.

3. The disc drive according to claim 1, wherein an elastic arm having a T-shape is disposed at one side of said disc loading device, a clip is extended from one end of said elastic arm for clipping said disc in said disc loading device, and a raised block is disposed in said disc drive; when said disc loading device is rotated into said disc drive, the other end of said elastic arm is pressed by said raised block to cause said elastic arm to release said disc form said clip.

4. The disc drive according to claim 1, wherein said joint mechanism comprises:
a joint body pivotally installed in said housing, and driven by said disc loading device to move from an unloaded position to a loaded position;
a sliding block moving together with said joint body for driving said base seat between said lower position and said higher position; and
an elastic element connected to said joint body for moving said joint body from said loaded position to said unloaded position.

5. The disc drive according to claim 4, further comprising a guide block installed in said housing adjacent to said base seat, and a sliding groove being disposed on said guide block for guiding said sliding block to move along said sliding groove.

6. The disc drive according to claim 4, wherein one end of said joint body is provided with a pin, and an ear is extended from one side of said sliding block, said ear has a sliding groove engaged with said pin, and said pin is slid therein to move said sliding block when said joint body is moved from said unloaded position to said loaded position.

7. The disc drive according to claim 4, wherein a joint pin is installed on said base seat adjacent to said sliding block, and a sloped guide groove is disposed at one side of said sliding block engaged with said joint pin, said joint pin is moved in said sloped guide groove to move said base seat together between said lower position and said higher position when said sliding block moves.

8. The disc drive according to claim 1, further comprising a locking mechanism installed in said housing for locking said disc loading device, in which said locking mechanism comprises a hook for locking said disc loading device; an electromagnetic plunger for controlling said hook to lock and release said disc loading device; and an elastic element for elastically moving said hook.
